(19) United States
(12) Patent Application Publication
(10) Pub. No.: US 2014/0019795 A1
(43) Pub. Date: Jan. 16, 2014

(54) COMPUTER PRODUCT, COUNTERMEASURE SUPPORT APPARATUS, AND COUNTERMEASURE SUPPORT METHOD

(71) Applicant: FUJITSU LIMITED, Kawasaki-shi (JP)

(72) Inventors: Masataka SONODA, Kawasaki (JP); Yasuhide MATSUMOTO, Kawasaki (JP); Yukihiro WATANABE, Kawasaki (JP)

(73) Assignee: FUJITSU LIMITED, Kawasaki-shi (JP)

(21) Appl. No.: 14/029,446

(22) Filed: Sep. 17, 2013

Related U.S. Application Data
(63) Continuation of application No. PCT/JP2011/056657, filed on Mar. 18, 2011.

(51) Int. Cl. G06F 11/07

(52) U.S. Cl. CPC G06F 11/0793; G06F 11/079
USPC 714/2; 714/37

(57) ABSTRACT

A computer-readable recording medium stores a countermeasure support program that causes a computer to execute a process that includes calculating a time period elapsing from an occurrence timing of a message that is of a predetermined type and related to an operation of an apparatus in a monitored system, until an occurrence timing of a fault; and outputting the calculated elapsed time period.

### CROSS REFERENCE TO RELATED APPLICATIONS

This application is a continuation application of International Application PCT/JP2011/056657, filed on Mar. 18, 2011 and designating the U.S., the entire contents of which are incorporated herein by reference.

### FIELD

The embodiments discussed herein are related to a countermeasure support program, a countermeasure support apparatus, and a countermeasure support method that support execution of a countermeasure against a fault.

### BACKGROUND

In a large-scale system such as an Internet data center (IDC), system operation has conventionally been executed of detecting a sign of a fault occurring in the system and taking a countermeasure before the fault becomes actualized.

For example, according to a related conventional technique, a presage pattern is extracted that is identified by the order in which events occurred in an apparatus to be monitored; and it is estimated that a fault occurs in the apparatus to be monitored when the presage pattern is detected in a monitored log. According to another technique, a limit value for a point at which an abnormality of a plant is monitored and the latest value of data of the plant are compared, and a warning condition and the latest value of the data of the plant are compared; and a warning is given if either of the results of the comparisons deviates from a predetermined range (see, e.g., Japanese Laid-Open Patent Publication Nos. 2007-172131 and 2009-75692).

However, according to the conventional techniques, a problem arises in that it is difficult to select a countermeasure suitable for a fault for which a sign is detected. For example, a countermeasure may be selected that is not executable during the time from the detection of the sign of the fault until occurrence of the fault and therefore, before the countermeasure is completely executed, the fault may become actualized and a down-time may be caused.

### SUMMARY

According to an aspect of an embodiment, a computer-readable recording medium stores a countermeasure support program that causes a computer to execute a process that includes calculating a time period elapsing from an occurrence timing of a message that is of a predetermined type and related to an operation of an apparatus in a monitored system, until an occurrence timing of a fault; and outputting the calculated elapsed time period.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram of one example of a countermeasure support method according to a first embodiment;

FIG. 2 is an explanatory diagram of an example of a system configuration of a countermeasure support system according to a second embodiment;

FIG. 3 is a block diagram of a hardware configuration of the countermeasure support apparatus according to the second embodiment;

FIG. 4 is an explanatory diagram of an example of the contents of a fault case example DB;

FIG. 5 is an explanatory diagram of an example of the contents of a message pattern DB;

FIG. 6 is an explanatory diagram of an example of the contents of a candidate countermeasure DB;

FIG. 7 is a block diagram of a functional configuration of the countermeasure support apparatus according to the second embodiment;

FIG. 8 is an explanatory diagram of an example of the contents of a message DB;

FIG. 9 is an explanatory diagram of a specific example of a lead time estimation result;

FIG. 10 is an explanatory diagram of a specific example of a detection result table;

FIGS. 11A, 11B, 12A, and 12B are explanatory diagrams of an example of transition of the contents of the detection result table;

FIG. 13 is an explanatory diagram of a specific example of a candidate countermeasure list;

FIG. 14 is an explanatory diagram of an example of the contents of a message dictionary DB;

FIG. 15 is an explanatory diagram of an example of classification of a message;

FIG. 16 is an explanatory diagram of an example of identification of the occurrence time of a fault;

FIGS. 17 and 18 are flowcharts of an example of a lead time calculation process of the countermeasure support apparatus according the second embodiment; and

FIG. 19 is a flowchart of an example of a procedure for a candidate countermeasure selection process of the countermeasure support apparatus according to the second embodiment.

### DESCRIPTION OF EMBODIMENTS

Embodiments of a countermeasure support program, a countermeasure support apparatus, and a countermeasure support method will be described in detail with reference to the accompanying drawings.

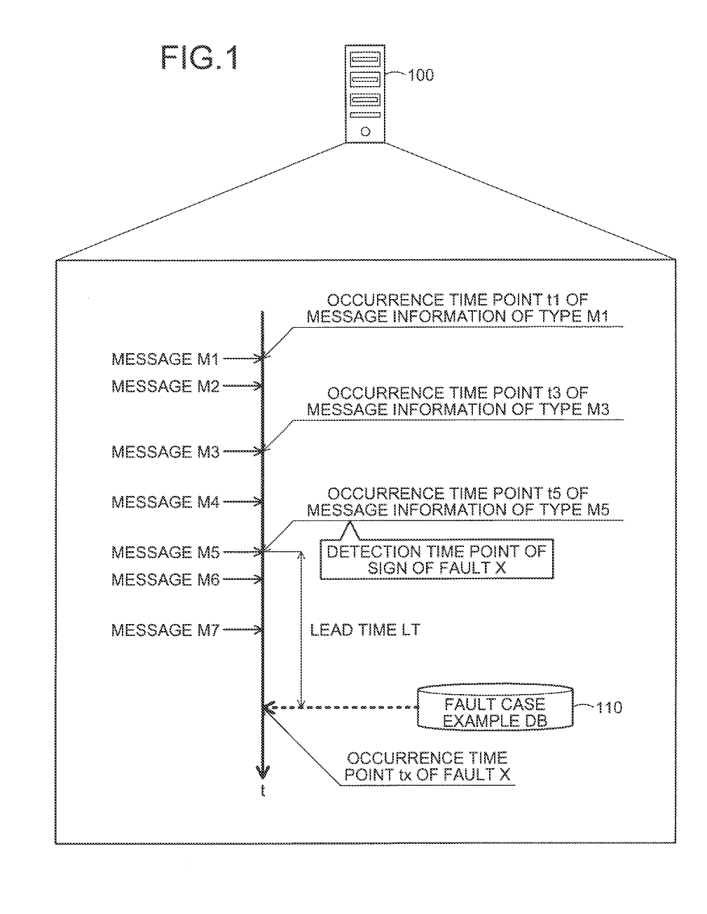

FIG. 1 is an explanatory diagram of one example of a countermeasure support method according to a first embodiment. In FIG. 1, a countermeasure support apparatus 100 is a computer that supports a countermeasure against a fault that occurs in a monitored system.

The monitored system is, for example, a large-scale system such as a cloud computing system constructed in an IDC. A fault that occurs in the system can be, for example, a high load on a server, a pressure on a network band, or a fault of a virtual machine (VM).

In the first embodiment, a countermeasure support method will be described according to which a time period from the detection of a sign of a fault until the occurrence of the fault is estimated, there facilitating selection of a candidate countermeasure suitable for the fault for which the sign is detected. An example of the countermeasure support method executed by the countermeasure support apparatus 100 will be described.

(1) The countermeasure support apparatus 100 acquires message information that includes occurrence timings of various events and the timing of each condition variation in an apparatus to be monitored in the system. The message information can be acquired in real time from one or more apparatuses to be monitored, or the message information can also be collectively acquired at a predetermined timing (regularly, a timing corresponding to the occurrence of a predetermined event, etc.) from each apparatus to be monitored. The events and the variation of the conditions occurring in the system can be stored in a storage device of each apparatus to be monitored, as a system log of an operating system (OS) or a log of an application.

The type of message represents the type to be used for classifying a message. For example, the message may be classified by type of event, nature thereof, linage thereof, etc. or may also be classified by degree of similarity between messages.

In the example depicted in FIG. 1, occurrence timings t1 to t7 are depicted in the temporal sequence, of messages M1 to M7 indicated by the acquired message information. In FIG. 1, “M#” denotes the type of message (#=1, 2, . . . , 7).

(2) The countermeasure support apparatus 100 monitors the collected message information and if the message information of one monitored apparatus corresponds to a predetermined type of message information, the countermeasure support apparatus 100 acquires an occurrence timing of the concerned message information. Alternatively, the countermeasure support apparatus 100 may temporarily store the acquired message including the occurrence timing thereof in a storage unit; later, may execute a search process for the message information stored in the storage unit; and if it is detected that a predetermined type of message information is stored, may acquire the occurrence timing of the message information.

The “predetermined type” may be determined as a type designated by an input operation executed using an input apparatus not depicted or may be determined as a type that is stored in advance. When the predetermined type is not directly designated and information identifying the type of fault is input from the input apparatus, the type of message corresponding to the input type of fault may be determined as the predetermined type.

When the countermeasure support apparatus 100 monitors the collected message information and the latest collected message information (Mn) corresponds to the predetermined type of message information, the countermeasure support apparatus 100 can acquire the occurrence timing of the predetermined type of message information (Mp) that is acquired before the acquisition of the latest collected message information (Mn). Plural predetermined types may also be employed and the countermeasure support apparatus 100 may also acquire the occurrence timing of each of the plural types of messages.

In the embodiment, a specific fault is denoted by “fault X” and a predetermined type to be a sign of the fault X, that occurs before the occurrence of the fault X is denoted by “types M1, M3, and M5”, as an example. In this case, message information of the types M1, M3, and M5 is searched for from a set of acquired message information.

(3) If message information of the types M1, M3, and M5, which are signs of the fault X, are retrieved, the countermeasure support apparatus 100 refers to a fault case example database (DB) 110 and identifies the time at which the fault X occurs. The fault case example DB 110 stores the occurrence time point of a fault for each case example of faults (including the fault X) that occur in the system.

In the example depicted in FIG. 1, the message information of the types M1, M3, and M5 are retrieved from the set of message information and as a result, an occurrence time point tx of the fault X is identified.

(4) The countermeasure support apparatus 100 calculates a lead time LT of the fault X based on occurrence time points t1, t3, and t5 of the retrieved message information of the types M1, M3, and M5; and the identified occurrence time point tx of the fault X. The “lead time LT” refers to a time period from the occurrence of a sign of the fault X until the occurrence of the fault X.

In the example depicted in FIG. 1, such a time interval is calculated as the lead time LT of the fault X, as that from the occurrence time point t5 of the message information of type M5 until the occurrence time point tx of the fault X. The countermeasure support apparatus 100 assumes that the occurrence time point t5 of the message information of type M5 is the time point at which the countermeasure support apparatus 100 detects the sign of the fault X, and calculates the remaining time period from the detection of the sign of the fault X until the occurrence of the fault X as the lead time LT.

A time interval between t1 and tx, or a time interval between t3 and tx may be calculated as the lead time LT. The calculated lead times LTs may be stored correlated with the fault X or the corresponding M1, M3, and M5. When a designation for any one among the fault X and M1, M3, and M5 is received by an operation of an input apparatus, the corresponding lead time LT may be output.

If it is detected that the collected latest message information corresponds to any one among M1, M3, and M5, the detected M1, M3, or M5, or the corresponding fault X may be handled as the designation. For example, if it is detected that the latest message information is M3, the lead time LT may also be output that is stored correlated with M3 or the fault X.

As described, according to the countermeasure support apparatus 100 according to the first embodiment, the lead time LT can be calculated that is from the detection of the sign of the fault until the occurrence of the fault. Thus, when a sign of a fault is detected in the system, a candidate countermeasure to be executed can be selected according to the lead time LT.

A countermeasure support system 200 according to a second embodiment will be described. Aspects identical to those described in the first embodiment will not again be described.

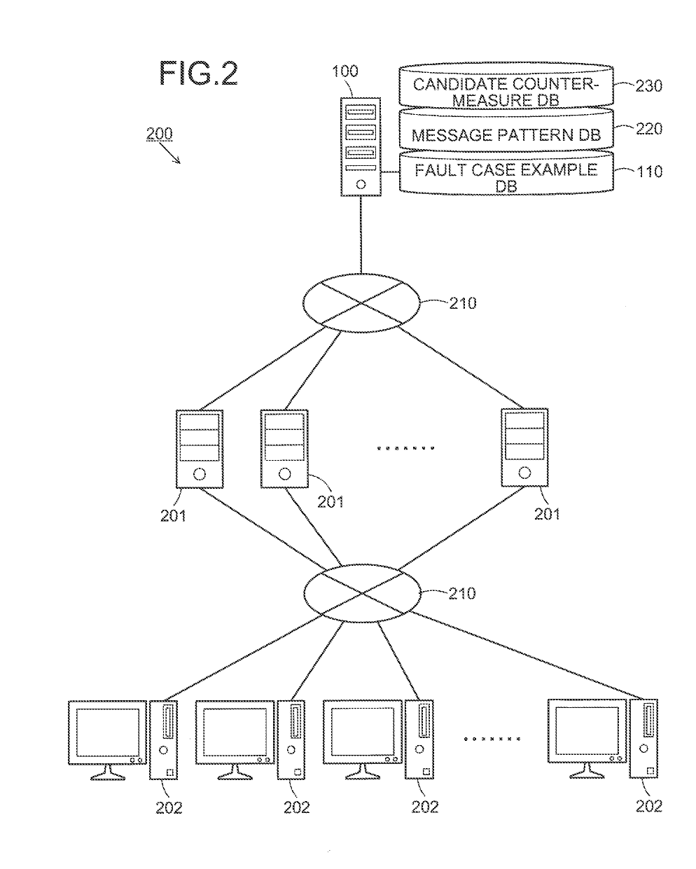

FIG. 2 is an explanatory diagram of an example of a system configuration of a countermeasure support system according to the second embodiment. In FIG. 2, the countermeasure support system 200 includes the countermeasure support apparatus 100, plural servers 201 (three servers in FIG. 2), and plural client terminals 202 (four client terminals in FIG. 2). In the countermeasure support system 200, the countermeasure support apparatus 100, the plural servers 201, and the plural client terminals 202 are connected to each other through a network 210 such as the Internet, a local area network (LAN), a wide area network (WAN), etc.

The countermeasure support apparatus 100 is a computer that includes the fault case example DB 110, a message pattern DB 220, and a candidate countermeasure DB 230 and that supports a countermeasure against a fault occurring in the countermeasure support system 200. The countermeasure support apparatus 100 is used by, for example, a manager of the countermeasure support system 200.

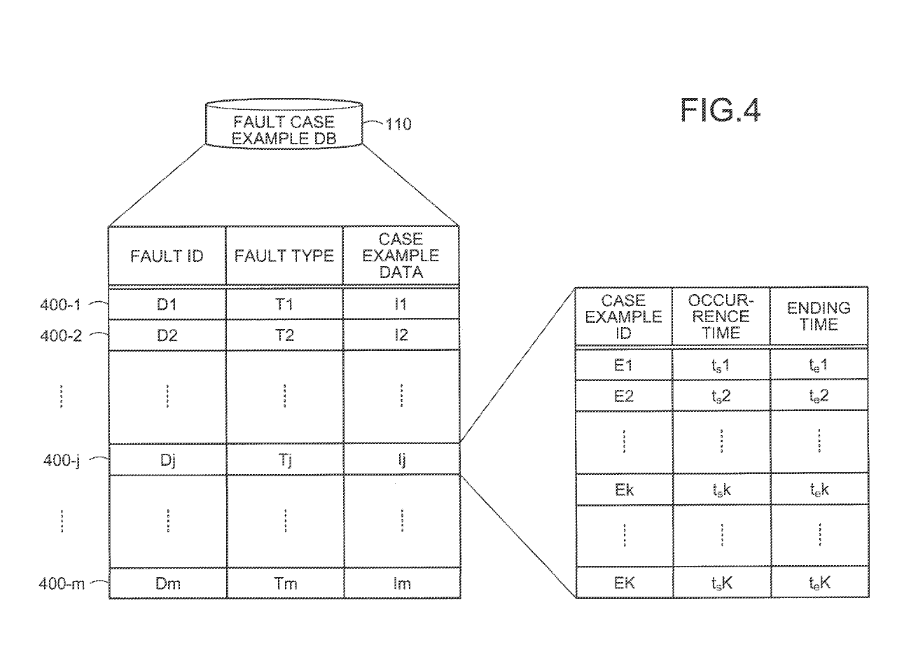

The fault case example DB 110 is a database that stores the occurrence time point of a fault for each case example of the faults occurring in the countermeasure support system 200. The message pattern DB 220 is a database that stores the message patterns that are signs of faults. The candidate countermeasure DB 230 is a database that correlates and stores candidate countermeasures against the faults and the necessary time periods to execute the candidate countermeasures. Detailed description of the DBs 110, 220, and 230 will be given later with reference to FIGS. 4 to 6.

The server 201 is a computer that provides a service in response to a request from the client terminal 202, and has a function of providing the countermeasure support apparatus 100 with a log of the OS or an application that is currently executed. The server 201 is, for example, a web server, an application server, a database server, a mail server, etc.

The client terminal 202 is a computer that is used by a user of a service provided by the server 201 and is, for example, a personal computer (PC), a portable information terminal, etc.

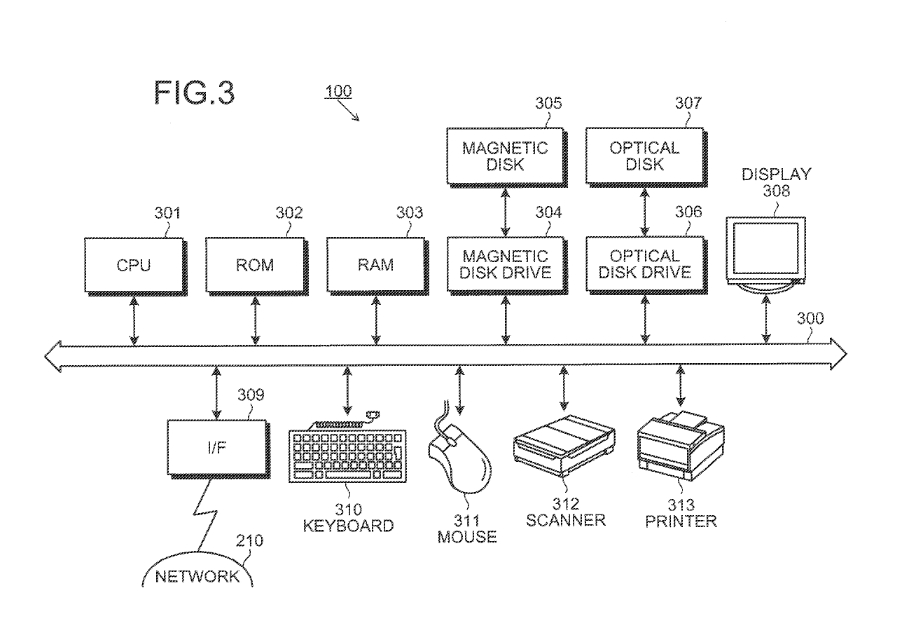

FIG. 3 is a block diagram of a hardware configuration of the countermeasure support apparatus according to the second embodiment. As depicted in FIG. 3, the countermeasure support apparatus 100 includes a central processing unit (CPU) 301, a read-only memory (ROM) 302, a random access memory (RAM) 303, a magnetic disk drive 304, a magnetic disk 305, an optical disk drive 306, an optical disk 307, a display 308, an interface (I/F) 309, a keyboard 310, a mouse 311, a scanner 312, and a printer 313, respectively connected by a bus 300.

The CPU 301 governs overall control of the countermeasure support apparatus 100. The ROM 302 stores therein programs such as a boot program. The RAM 303 is used as a work area of the CPU 301. The magnetic disk drive 304, under the control of the CPU 301, controls the reading and writing of data with respect to the magnetic disk 305. The magnetic disk 305 stores therein data written under control of the magnetic disk drive 304.

The optical disk drive 306, under the control of the CPU 301, controls the reading and writing of data with respect to the optical disk 307. The optical disk 307 stores therein data written under control of the optical disk drive 306, the data being read by a computer.

The display 308 displays, for example, data such as text, images, functional information, etc., in addition to a cursor, icons, and/or tool boxes. A cathode ray tube (CRT), a thin-film-transistor (TFT) liquid crystal display, a plasma display, etc., may be employed as the display 308.

The I/F 309 is connected to the network 210 through a communication line and is connected to other apparatuses through the network 210. The I/F 309 administers an internal interface with the network 210 and controls the input/output of data from/to external apparatuses. For example, a modem or a LAN adaptor may be employed as the I/F 309.

The keyboard 310 includes, for example, keys for inputting letters, numerals, and various instructions and performs the input of data. Alternatively, a touch-panel-type input pad or numeric keypad, etc. may be adopted. The mouse 311 is used to move the cursor, select a region, or move and change the size of windows. A track ball or a joy stick may be adopted provided each respectively has a function similar to a pointing device.

The scanner 312 optically reads an image and takes in the image data into the countermeasure support apparatus 100. The scanner 312 may have an optical character reader (OCR) function as well. The printer 313 prints image data and text data. The printer 313 may be, for example, a laser printer or an ink jet printer.

The server 201 and the client terminal 202 depicted in FIG. 2 can each be also implemented by the same hardware configuration as that of the countermeasure support apparatus 100.

The contents of each of the DBs 110, 220, and 230 that are included in the countermeasure support apparatus 100 will be described. The DBs 110, 220, and 230 are implemented by, for example, a storage device such as the RAM 303, the magnetic disk 305, and the optical disk 307 depicted in FIG. 3.

FIG. 4 is an explanatory diagram of an example of the contents of the fault case example DB. In FIG. 4, the fault case example DB 110 has fields for the fault ID, the fault type, and the case example data. By setting information into the fields, fault case example information 400-1 to 400-m of the faults D1 to Dm is stored in the fault case example DB 110 as records.

The fault ID is an identifier of a fault that occurs in the countermeasure support system 200. The fault type is the type that characterizes a fault. Fault types include, for example, a high load on the server, an abnormality of a network card, an abnormality of a hard disk drive (HDD), and a competition of disk inputs and outputs (IO). The case example data is information that indicates the occurrence time and the ending time for each case example of the faults. The case example ID is an identifier of a case example.

For example, fault case example information 400-j indicates the fault type Tj and the case example data Ij of a fault Dj (j=1, 2, . . . , m). The case example data Ij indicates the occurrence time tₛk and the ending time tₑk for each of the case example Ek of the fault Dj (k=1, 2, . . . , k). The contents of the fault case example DB 110 is updated each time a new fault occurs in the countermeasure support system 200.

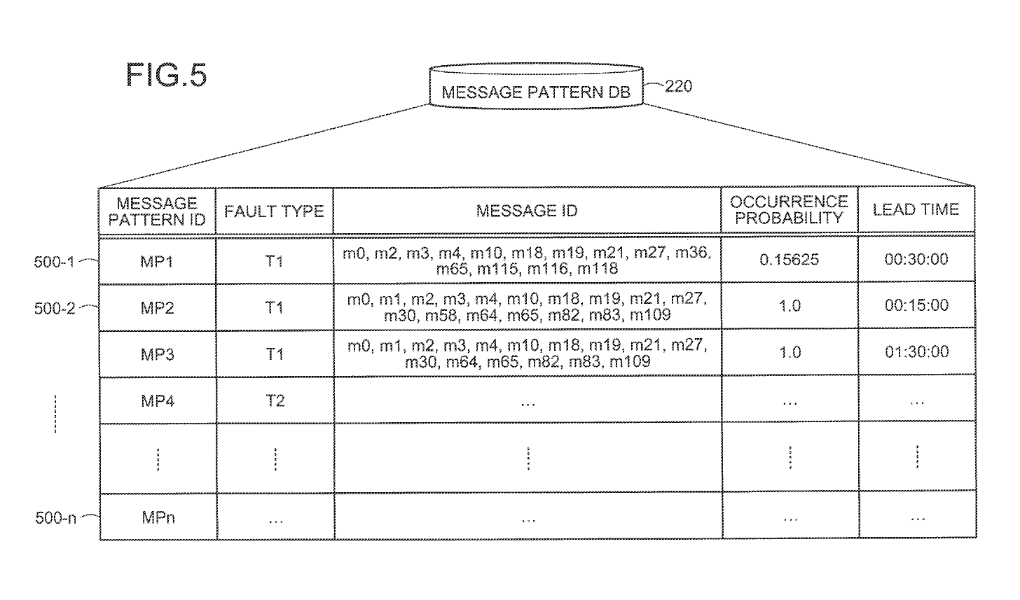

FIG. 5 is an explanatory diagram of an example of the contents of the message pattern DB. In FIG. 5, the message pattern DB 220 has fields for the message pattern ID, the fault type, the message ID, the occurrence probability, and the lead time. By setting information into the fields, message pattern information 500-1 to 500-n of the message patterns MP1 to MPn is stored in the message pattern DB 220 as records.

The message pattern ID is an identifier of a message pattern. The message pattern represents a combination of message IDs of the messages that occur before the occurrence of a specific fault and that are the signs of the specific fault. The message is included in a log that represents an operation record of the server 201. The message ID corresponds to the “type of message” described in the first embodiment. The “fault type” is the type that characterizes a fault.

The message ID is an identifier that is used to classify a message. The occurrence probability is the probability of the occurrence of a specific fault when a message of a message ID included in the message pattern occurs in the countermeasure support system 200. The lead time is a time period from the detection of the sign of a fault until the occurrence of the fault.

Taking the message pattern information 500-1 as an example, the message pattern MP1 is shown, which indicates a combination of the message IDs of the messages that are the signs of a fault of the fault type T1. When a message of the message ID included in the message pattern MP1 occurs in the countermeasure support system 200, the occurrence probability “0.15625” at which the fault of the fault type T1 occurs is shown, and the lead time “00:30:00 (hour:minute:second) that spans from the occurrence of the sign of the fault of the fault type T1 until the occurrence of the fault is also shown.

The message patterns of the same fault type represent subsets of a set of the message IDs having co-occurrence relations with faults of the same fault type. The “co-occurrence relation” refers to a relation between two events that, when one (for example, “the set of message IDs”) occurs, the other (for example, “the fault”) is highly likely to occur.

For example, message patterns MP1 to MP3 respectively represent subsets of a message ID set “m0, m1, m2, m3, m4, m10, m18, m19, m21, m27, m30, m36, m58, m64, m65, m82, m83, m109, m115, m116, m118” having co-occurrence relations with a fault of the type T1.

In the description below, an arbitrary message pattern of the message patterns MP1 to MPn will be written as “message pattern MPi”; the fault type of the message pattern MPi will be written as “fault type T”; and the lead time of the message pattern MPi will be written as “lead time LTi”.

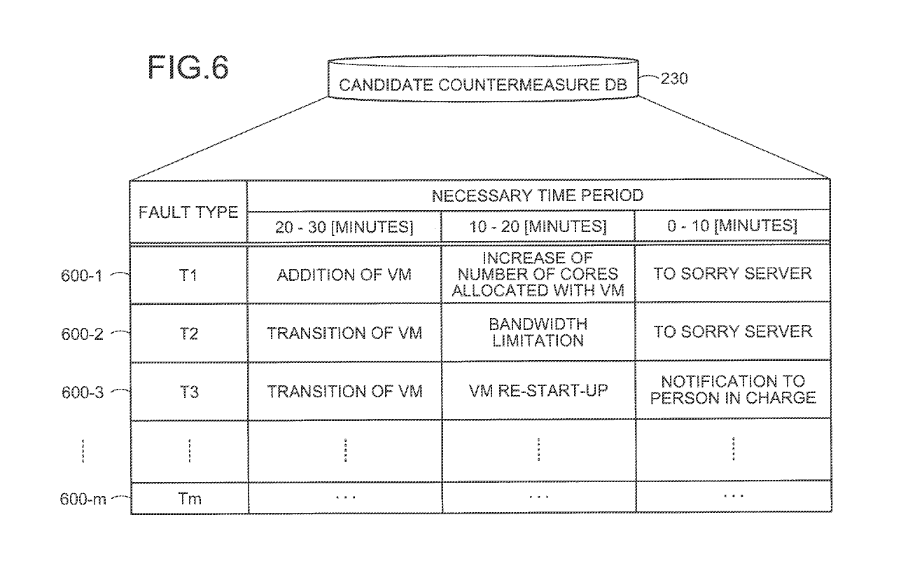

FIG. 6 is an explanatory diagram of an example of the contents of the candidate countermeasure DB. In FIG. 6, the candidate countermeasure DB 230 stores for each fault type, candidate countermeasure information 600-1 to 600-m that indicates the candidate countermeasures against a fault of the fault type and the time period necessary for the execution of the candidate countermeasure against the fault.

Taking the candidate countermeasure information 600-1 as an example, such items are indicated as the candidate countermeasure “addition of a VM” against the fault of the fault type T1, and the time period “20 to 30 [minutes]” necessary for executing the candidate countermeasure “addition of the VM”. “20 to 30 [minutes]” expresses a time period that is equal to or longer than 20 minutes and that is equal to or shorter than 30 minutes. Such items are also indicated therein as the candidate countermeasure against a fault of the fault type T1 “an increase of the number of cores allocated with the VM” and the time period “10 to 20 [minutes]” necessary for executing the candidate countermeasure “an increase of the number of cores allocated with the VM”.

The candidate countermeasure information 600-1 also indicates the candidate countermeasure “progress to using a sorry server” against a fault of the fault type T1, and the time period “0 to 10 [minutes]” necessary for executing the candidate countermeasure “progress to using a sorry server”. The “sorry server” is a server that sends a response notifying that no service can be provided, to the client terminal 202 when no service can be provided during, for example, the occurrence of a fault of the server 201.

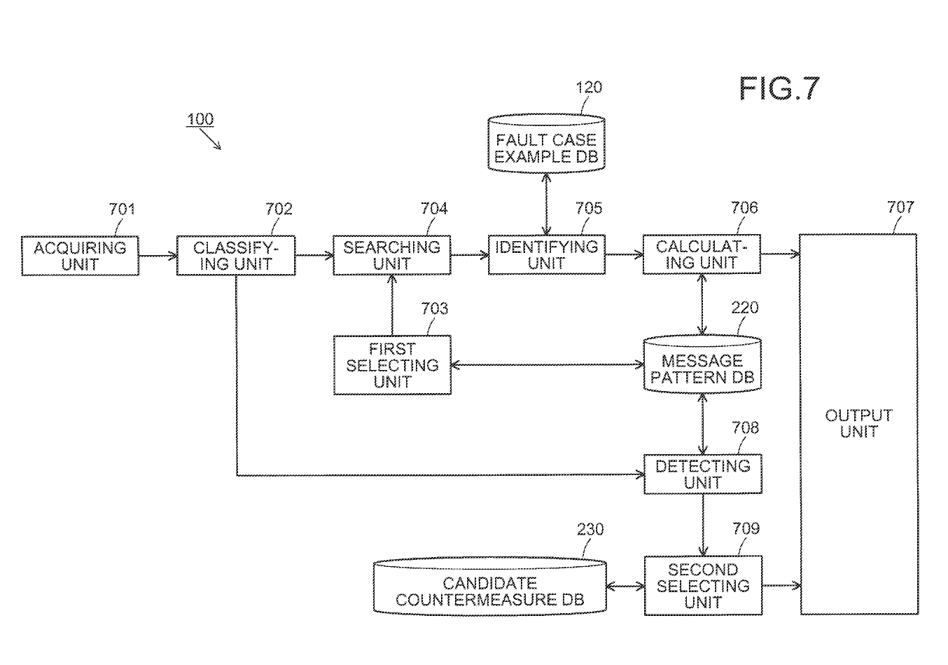

An example of a functional configuration will be described of the countermeasure support apparatus 100 according to the second embodiment. FIG. 7 is a block diagram of a functional configuration of the countermeasure support apparatus according to the second embodiment. In FIG. 7, the countermeasure support apparatus 100 includes an acquiring unit 701, a classifying unit 702, a first selecting unit 703, a searching unit 704, an identifying unit 705, a calculating unit 706, an output unit 707, a detecting unit 708, and a second selecting unit 709. Functions (units from the acquiring unit 701 to the second selecting unit 709) forming a control unit, for example, are implemented by causing the CPU 301 to execute programs stored in a storage device such as the ROM 302, the RAM 303, the magnetic disk 305, and the optical disk 307 depicted in FIG. 3, or by using the I/F 309. The processing results of the functional units are stored to a storage device such as, for example, the RAM 303, the magnetic disk 305, and the optical disk 307.

The acquiring unit 701 has a function of acquiring a log that represents a record of the operation of the server 201. For example, the acquiring unit 701 receives the log representing the record of the operation of the server 201 from the server 201 through the network 210. The log represents the record of the various events and the variation of the condition that occurs in the countermeasure support system 200.

The log includes a message that indicates, for example, the data and the time, the host name, the process name, and details of an event. The “date and time” are the date and the time of the output of the log. The “host name” is an identifier of the server 201 that outputs the log. The “process name” is the name of a process of software (the OS or an application) related to the log. The “details of an event” are details of the event that relates to the log.

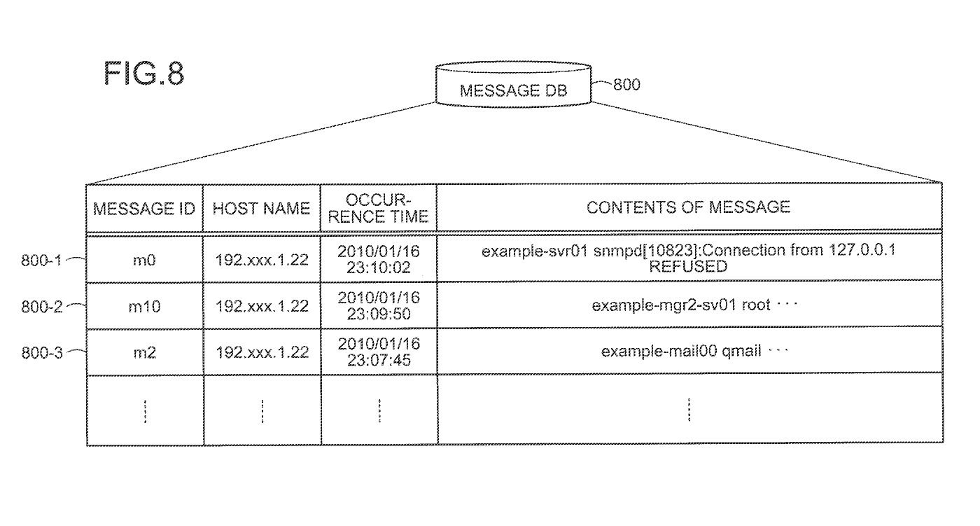

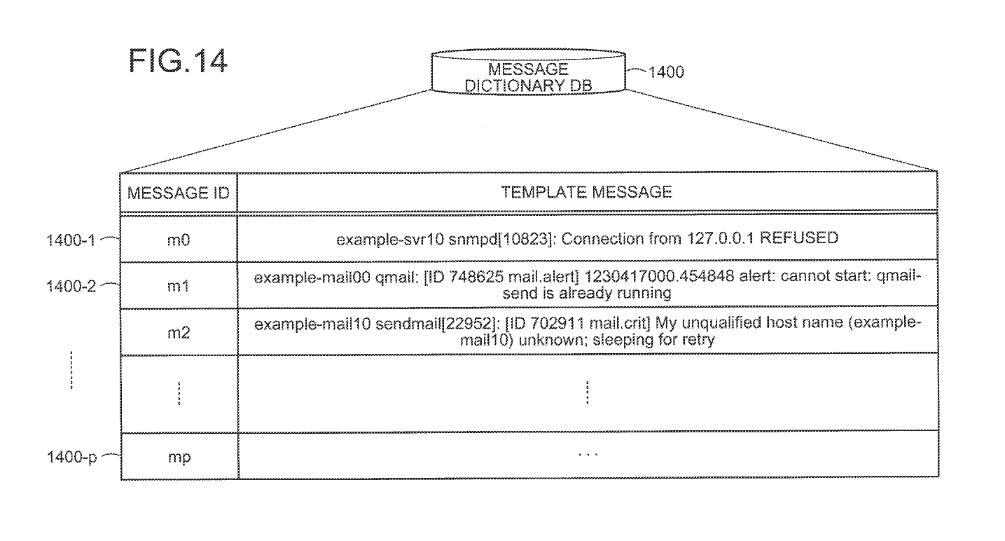

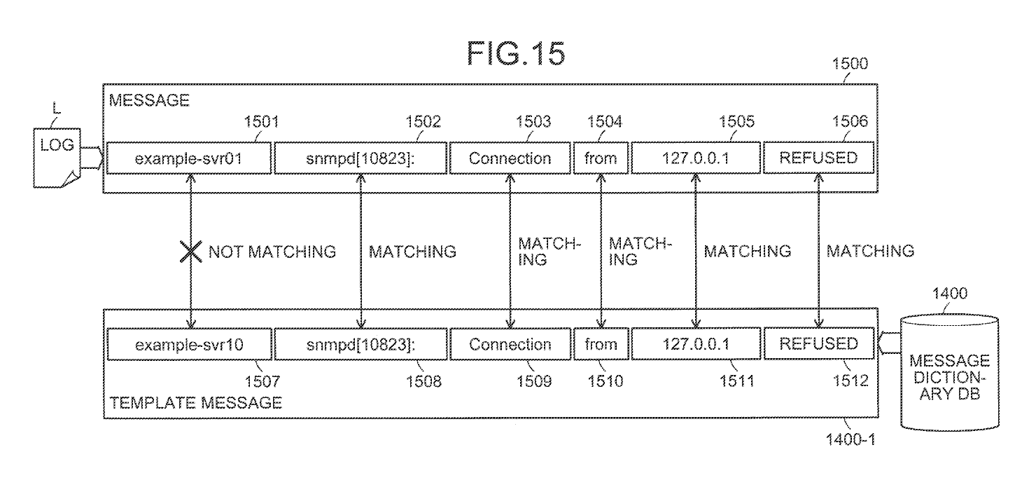

The classifying unit 702 has a function of classifying the acquired log. For example, the classifying unit 702 classifies the log based on the message included in the acquired log. Detailed contents of the processing executed by the classifying unit 702 will be described later with reference to FIGS. 14 and 15. The classification result acquired by the classification is stored in, for example, a message DB 800 depicted in FIG. 8. The message DB 800 will be described.

FIG. 8 is an explanatory diagram of an example of the contents of the message DB. In FIG. 8, the message DB 800 has fields for the message ID, the host name, the occurrence time, and the message contents. By setting information into the fields, message information (for example, message information 800-1 to 800-3) is stored in the message DB 800 as records.

The “message ID” is an identifier used to classify a message. The “host name” is an identifier (for example, an IP address) of the server 201. The “occurrence time” is the time of the occurrence of the message. The occurrence time is the date and the time of the output of the log that includes the message. The “message contents” are the contents of the description in the message included in the log.

The message information in the message DB 800 corresponds to each of the logs acquired from the server 201. Groups of message information in the message DB 800 are stored therein sorted in descending order of the occurrence time of the message.

Taking the message information 800-1 as an example, such items are indicated as the host name “192.xxx.1.22” that outputs the log including a message m0, the occurrence time “2010/01/16 23:10:02” of the message m0, and the message content “example-svr01 snmpd [10823]:Connection from 127.0.0.1 REFUSED” of the message m0.

Reference of the description returns to FIG. 7. The first selecting unit 703 has a function of selecting any one message pattern MPi from among the message patterns MP1 to MPn. For example, the first selecting unit 703 sequentially selects the message pattern MPi from the message pattern DB 220 depicted in FIG. 5 in ascending order of message pattern ID (MP1→MP→ . . . ). For example, the first selecting unit 703 may select any one message pattern MPi according to a user selection input via the keyboard 310 and the mouse 311 depicted in FIG. 3.

The searching unit 704 has a function of searching the classification result acquired by the classification for the messages of the message IDs included in the selected message pattern MPi. For example, the searching unit 704 extracts a group of message information for a predetermined time period a from the message DB 800 depicted in FIG. 8, and searches the extracted group of message information for message information that corresponds to the message IDs included in the message pattern MPi.

For example, the searching unit 704 searches the group of message information for the message information 800-1 that corresponds to the message ID “m0” included in the message pattern MP1. Thereby, the searching unit 704 can retrieve the message m0 that is included in the message pattern MP1. The predetermined time period a (for example, 60 or 120 minutes) is set in advance and is stored in a storage device such as the ROM 302, the RAM 303, the magnetic disk 305, and the optical disk 307.

In the following description, the messages of the message IDs included in the message pattern MPi will be written as “messages m[1] to m[K]”. An arbitrary message of the messages m[1] to m[K] will be written as “message m[k]” (k=1, 2, . . . , K).

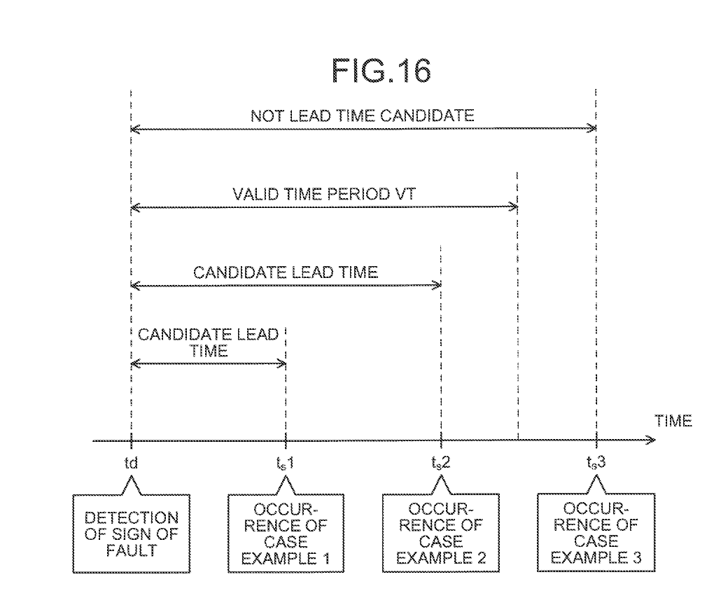

The identifying unit 705 has a function of identifying an occurrence time point of a fault of the fault type T in the message pattern MPi. For example, the identifying unit 705 refers to the fault case example DB 110 and identifies the occurrence time of the fault of the fault type T1 in the message pattern MP1 when the searching unit 704 retrieves all of the messages m[1] to m[K] included in the message pattern MPi. Detailed contents of the processing executed by the identifying unit 705 will be described later with reference to FIG. 16.

The calculating unit 706 has a function of calculating the lead time LTi, based on the identified occurrence time point of the fault of the fault type T and the occurrence time point of any one message m[k] among the retrieved messages m[1] to m[K]. The lead time LTi is a time period spanning from the time when the sign of the fault of the fault type T is detected until the time when the fault of the fault type T occurs.

For example, the calculating unit 706 may calculate the time interval from the occurrence time of the latest message m[k] whose occurrence time is the latest among the messages m[1] to m[K] until the occurrence time of the fault of the fault type T, as the lead time LTi. Thereby, the calculating unit 706 can calculate the lead time LTi determining that the occurrence time of the message m[k] whose occurrence time is the latest among the messages m[1] to m[K] that represent the signs of the fault, as the detection time of the sign.

For example, it is assumed that the occurrence time is “2009/03/02 23:15:00” of the message m3 whose occurrence time is the latest among the group of messages included in the message pattern MP1 and that the occurrence time of the fault of the fault type T1 is “2009/03/02 23:45:00”. In this case, the calculating unit 706 calculates the time interval “00:30:00” that spans from the occurrence time “2009/03/02 23:15:00” of the message m3 until the occurrence time “2009/03/02 23:45:00” of the fault of the fault type T1. As a result, the calculating unit 706 calculates the lead time LT1 “00:30:00” from the occurrence of the sign of the fault of the fault type T1 until the occurrence of the fault.

The calculating unit 706 may use the occurrence time that is the oldest among the occurrence times of the messages m[1] to m[K] or the average value of the occurrence times of the messages m[1] to m[K], as the occurrence time of the message m[k] that is used for calculating the lead time LTi.

The calculation result acquired by the calculation is stored in the message pattern DB 220 depicted in FIG. 5. For example, when the calculating unit 706 calculates the lead time LT1 “00:30:00” of the fault type T1 for the message pattern MP1, the calculating unit 706 sets “00:30:00” in the lead time field of the message pattern information 500-1.

When the calculating unit 706 newly calculates a second lead time after calculating the lead time LTi of the message pattern MPi (in this case, referred to as “first lead time”), the calculating unit 706 may calculate the lead time LTi based on the first and the second lead times.

For example, the calculating unit 706 may calculate the average value of the first and the second lead times and thereby, may calculate the lead time LTi. For example, if the calculating unit 706 calculates the second lead time “00:20:00” after calculating the first lead time “00:30:00” for the message pattern MP1, the calculating unit 706 determines that the average value “00:25:00” of the first and the second lead times is the lead time LT1. Thereby, the lead time LTi can be statistically acquired from the plural calculation results and thereby, deviations in the lead time LTi can be reduced.

For example, the calculating unit 706 may select the lead time that is shorter among the first and the second lead times and thereby, may calculate the lead time LTi. Thereby, the shortest remaining time period from the detection of the sign of the fault to the occurrence of the fault can be employed as the lead time LTi.

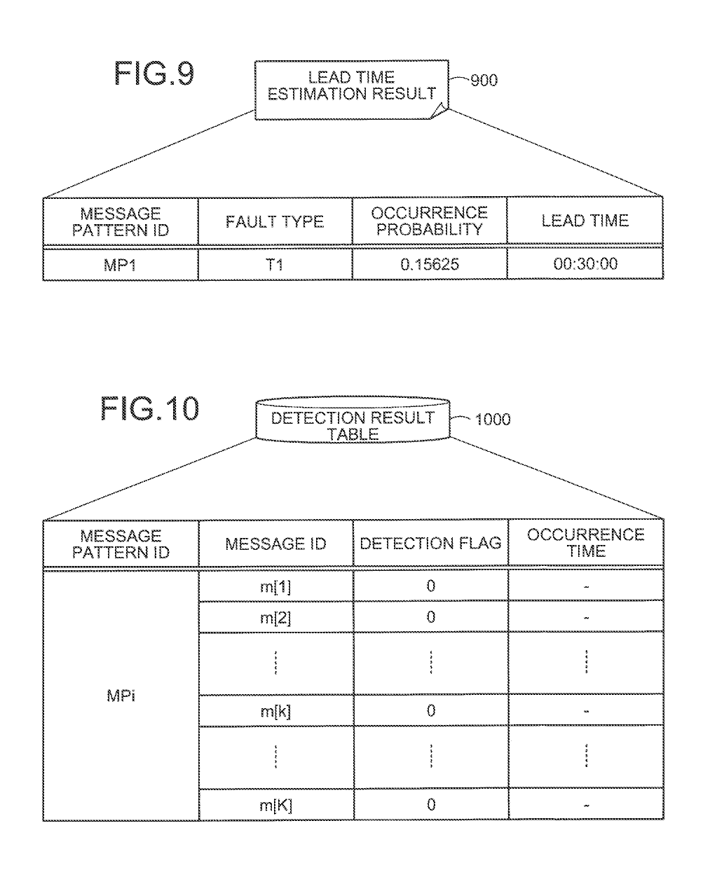

The output unit 707 has a function of outputting the calculated lead time LTi that is from the detection of the sign of the fault of the fault type T until the occurrence of the fault. For example, the output unit 707 may output a lead time estimation result 900 as depicted in FIG. 9. A specific example of the lead time estimation result 900 will be described.

FIG. 9 is an explanatory diagram of the specific example of the lead time estimation result. In FIG. 9, the lead time estimation result 900 shows the occurrence probability “0.15625” of the fault of the fault type T1 that occurs with the message pattern MP1 as its sign, and the lead time LT1 “00:30:00”.

According to the lead time estimation result 900, when the message pattern MP1, which is the sign of the fault of the fault type T1, is detected, the manager of the countermeasure support system 200 can grasp that the fault occurs 30 minutes after the time of the detection of the message pattern MP1. When the sign of the fault of the fault type T1 is detected, the manager can grasp the probability of the occurrence of the fault.

The form of output by the output unit 707 can be, for example, display on the display 308, output to the printer 313 for printing, or transmission to an external apparatus using the I/F 309. Further, the output of the output unit 707 may be stored to a storage area such as the RAM 303, the magnetic disk 305, and the optical disk 307.

Reference of the description returns to FIG. 7. The detecting unit 708 has a function of detecting the message m[k] of the message ID included in the message pattern MPi. For example, each time a log acquired from the server 201 is classified, the detecting unit 708 determines whether the message ID of the classified log acquired after the classification is included in the message pattern MPi.

If the detecting unit 708 determines that the message ID of the classified log acquired after the classification is included in the message pattern MPi, the detecting unit 708 detects the message m[k] that corresponds to the message ID of the log. The detection result acquired by the detection is stored to, for example, a detection result table 1000 depicted in FIG. 10. The detection result table 1000 will be described.

FIG. 10 is an explanatory diagram of a specific example of the detection result table. In FIG. 10, the detection result table 1000 has fields for the message pattern ID, the message ID, the detection flag, and the occurrence time. By setting information into the fields, the detection results of the messages m[1] to m[K] included in the message pattern MPi are stored in the detection result table 1000 as records.

The message pattern ID is an identifier of the message pattern MPi. The message ID is an identifier of a message. The detection flag is a flag that indicates whether a message is detected. The detection flag indicates “0” in its initial state and, when the message is detected, is changed from “0” to “1”. The occurrence time is the occurrence time of the message.

The detection result table 1000 is produced, for example, for each of the message patterns MP1 to MPn. Taking the message pattern MP1 as an example, an example of transition of the contents of the detection result table 1000 will be described.

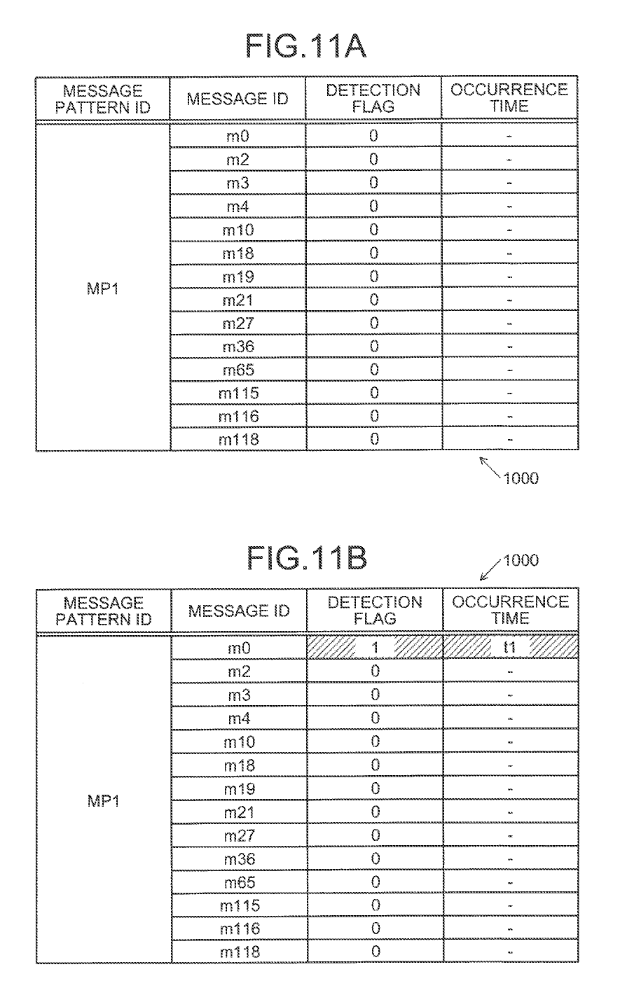

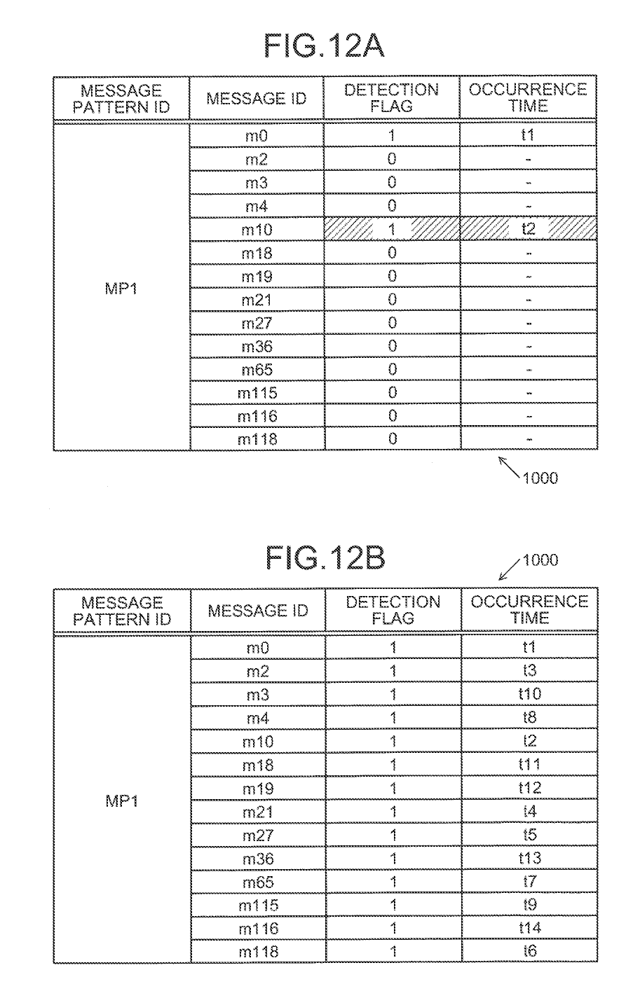

FIGS. 11A, 11B, 12A, and 12B are explanatory diagrams of an example of transition of the contents of the detection result table. In FIG. 11A, “MP1” is set in the message pattern ID field in the detection result table 1000; and “m0, m2, m3, m4, m10, m18, m19, m21, m27, m36, m65, m115, m116, and m118” are set in the message ID field.

In FIG. 11B, the message m0 included in the message pattern MP1 is detected and as a result, the detection flag of the message m0 in the detection result table 1000 is changed from “0” to “1”. The occurrence time “t1” of the message m0 is set in the occurrence time field of the message m0.

In FIG. 12A, the message m10 included in the message pattern MP1 is detected and as a result, the detection flag of the message m10 in the detection result table 1000 is changed from “0” to “1”. The occurrence time “t2” of the message m10 is set in the occurrence time field of the message m10.

A case is assumed where, the remaining messages m2, m3, m4, m18, m19, m21, m27, m36, m65, m115, m116, and m118 included in the message pattern MP1 are thereafter sequentially detected.

In FIG. 12B, the remaining messages included in the message pattern MP1 are detected and as a result, the detection flags of all the messages in the detection result table 1000 are each changed from “0” to “1” and the occurrence times of all the messages are set.

As described, according to the detection result table 1000, the detection state can be grasped in real time of each message m[k] that is included in the message pattern MPi. Thereby, the time point at which the detection of all the messages m[1] to m[K] included in the message pattern MPi is completed can quickly be grasped.

Although description has been given such that the detecting unit 708 determines whether the message ID of the log acquired after the classification is included in the message pattern MPi, each time the log acquired from the server 201 is classified, the determination is not limited hereto.

For example, the detecting unit 708 may first extract the latest message information for a given time period β from the message DB 800 each time the given time period β elapses and may detect the message m[k] of the message ID included in the message pattern MPi.

The given time period β (for example, 10 or 20 minutes) is, for example, set in advance and is stored in a storage device such as the ROM 302, the RAM 303, the magnetic disk 305, and the optical disk 307.

Reference of the description returns to FIG. 7. The output unit 707 has a function of outputting the lead time LTi of the message pattern MPi when the message m[k] of the message ID that is included in the message pattern MPi is detected. For example, when all the messages are detected that are included in the message pattern MP1, the output unit 707 may output the lead time estimation result 900 as depicted in FIG. 9.

Thus, the manager of the countermeasure support system 200 can grasp that the message pattern MP1 to be the sign of the fault of the fault type T1 has been detected and that the fault occurs 30 minutes after the detection time of the message pattern MP1, and can further grasp the probability of the occurrence of the fault when the sign of the fault of the fault type T1 is detected.

The second selecting unit 709 has a function of selecting a candidate countermeasure against the fault of the fault type T based on the calculated lead time LTi when the messages m[1] to m[K] included in the message pattern MPi are detected. The lead time LTi of the message pattern MPi is identified from, for example, the message pattern DB 220 depicted in FIG. 5.

For example, when the detection flags of all the messages in the detection result table 1000 each indicate “1”, the second selecting unit 709 extracts the candidate countermeasure information 600-j that corresponds to the fault type T of the message pattern MPi, from the candidate countermeasure DB 230 depicted in FIG. 6. The second selecting unit 709 refers to the extracted candidate countermeasure information 600-j and selects the candidate countermeasure whose time period necessary for execution is shorter than the lead time LTi.

In this case, when plural candidate countermeasures are present whose time periods necessary for execution each is shorter than the lead time LTi, the second selecting unit 709 may select a candidate countermeasure whose time period necessary for execution is the longest or may select all the candidate countermeasures whose time periods necessary for execution are each shorter than the lead time LTi.

For example, when the detection flags each indicate “1” for all the messages in the detection result table 1000 of the message pattern MP1 depicted in FIG. 12, the second selecting unit 709 selects the candidate countermeasure of the fault type T1 from the candidate countermeasure DB 230. For example, the second selecting unit 709 selects the candidate countermeasure “addition of the VM” whose time period necessary for execution is the longest, from among the candidate countermeasures whose time periods necessary for execution are each shorter than the lead time LT1 “00:30:00”.

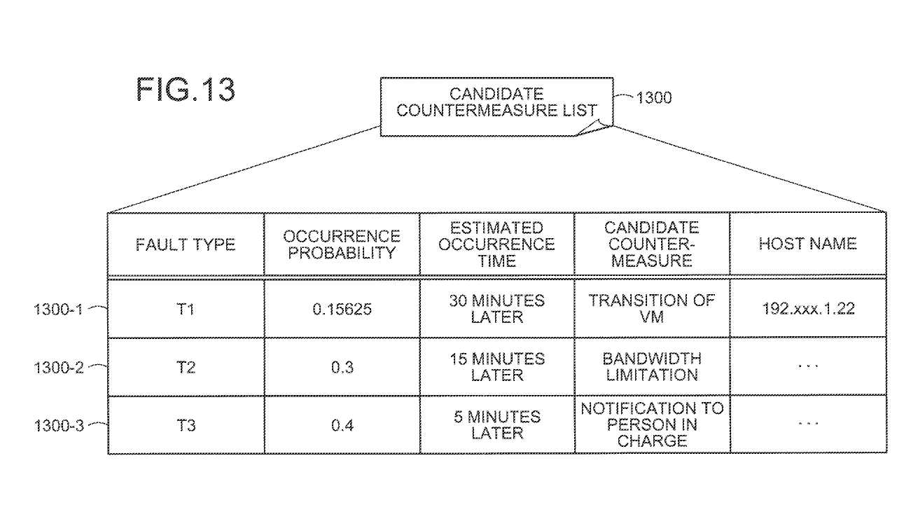

The output unit 707 has a function of outputting the selected candidate countermeasure of the fault of the fault type T. For example, the output unit 707 may output a candidate countermeasure list 1300 as depicted in FIG. 13. A specific example of the candidate countermeasure list 1300 will be described.

FIG. 13 is an explanatory diagram of a specific example of the candidate countermeasure list. In FIG. 13, the candidate countermeasure list 1300 stores list information 1300-1 to 1300-3 that indicate the occurrence probability, the estimated occurrence time period, the candidate countermeasure, and the host name for each fault type of the fault for which a sign is detected. The candidate countermeasure list 1300 is an example of a case where plural signs of the fault are detected.

The occurrence probability is an occurrence probability of a fault for which a sign is detected. The estimated occurrence time period is a remaining time period from the detection of the sign of the fault to the occurrence of the fault. The candidate countermeasure is a candidate countermeasure selected by the second selecting unit 709 and is a nominee of the candidate countermeasures against the fault for which the sign is detected. The host name is the name of a host that outputs the log including the message m[k] included in the message pattern MPi.

For example, the list information 1300-1 indicates the occurrence probability “0.15625” of the fault of the fault type T1, the estimated occurrence time period “30 minutes later”, the candidate countermeasure “transition of the VM”, and the host name “192.xxx.1.22”. Plural host names may be indicated for the host name.

The candidate countermeasure list 1300 enables the manager of the countermeasure support system 200 to grasp in advance the occurrence of the fault, the candidate countermeasure that corresponds to the remaining time period from the detection of the sign of the fault to the occurrence of the fault, and to identify the occurrence point of the fault for which the sign is detected, from the host name.

Thus, the candidate countermeasure list 1300 enables the manager of the countermeasure support system 200 to select and execute a candidate countermeasure suitable for the fault for which the sign is detected; and when, for example, signs are detected of plural faults whose estimated occurrence time periods are substantially equal, can cope with the state by taking countermeasures against the faults in descending order of occurrence probability, etc., by referring to the occurrence probabilities of the faults of the fault types T1 to T3.

For example, similarly to the detecting unit 708, the searching unit 704 may search for the messages m[1] to m[K] of the message IDs included in the message pattern MPi. For example, the searching unit 704 determines whether the message ID of the classified log acquired after the classification is included in the message pattern MPi each time a log acquired from the server 201 is classified.

If the searching unit 704 determines that the message ID of the log acquired after the classification is included in the message pattern MPi, the searching unit 704 searches for the message m[k] that corresponds to the message ID of the log. Search results acquired by the searching unit 704 are stored to a table whose data structure is same as that of the detection result table 1000 depicted in FIG. 10.

Thus, the state of a search for each message m[k] included in the message pattern MPi can be grasped in real time, and the time point at which all the messages m[1] to m[K] included in the message pattern MPi are retrieved can quickly be grasped.

An example will be described of specific contents of the processing executed by the classifying unit 702 to classify a log acquired from the server 201. A message dictionary DB 1400 that is used for classifying the log will be described. The message dictionary DB 1400 is stored in a storage device such as, for example, the RAM 303, the magnetic disk 305, and the optical disk 307.

FIG. 14 is an explanatory diagram of an example of the contents of the message dictionary DB. In FIG. 14, the message dictionary DB 1400 has fields for the message ID and a template message. By setting information into the fields, entries 1400-1 to 1400-p are stored in the message dictionary DB 1400 as records.

The message ID is an identifier of the template message and is an identifier used to classify the message included in the log. The template message is a message that is a template used to classify a message. For example, the entry 1400-1 represents a template message “example-svr10 snmpd [10823]:Connection from 127.0.0.1 REFUSED” of the message ID “m0”.

A case will be described with reference to FIG. 15 where “example-svr01 snmpd [10823]:Connection from 127.0.0.1 REFUSED” that is included in the log acquired from the server 201 is classified.

FIG. 15 is an explanatory diagram of an example of classification of a message. In FIG. 15, a message 1500 is depicted that is included in a log L acquired from the server 201.

The classifying unit 702 first selects an entry from the message dictionary DB 1400. For example, the classifying unit 702 sequentially selects entries in ascending order of message ID, from the message dictionary DB 1400. In the example of FIG. 15, the entry 1400-1 is selected from the message dictionary DB 1400.

The classifying unit 702 divides the message 1500 and the template message of the entry 1400-1. In the example of FIG. 15, the message 1500 is divided into phrases 1501 to 1506. The template message of the entry 1400-1 is divided into phrases 1507 to 1512.

Thereafter, the classifying unit 702 compares the message 1500 with the template message of the entry 1400-1 phrase by phrase and thereby, determines matching therebetween. In the example of FIG. 15, the phrase 1501 of the message 1500 does not match the phrase 1507 of the template message. The phrases 1502 to 1506 of the message 1500 match the phrases 1508 to 1512 of the template message.

The classifying unit 702 calculates the degree of similarity between the message 1500 and the template message of the entry 1400-1 based on the determination result acquired by the determination of matching. For example, the classifying unit 702 divides the number of matching phrases “10” by the total number of phrases “12” and thereby, calculates the degree of similarity “0.83≈10/12” between the message 1500 and the template message of the entry 1400-1.

The classifying unit 702 classifies the message 1500 based on the calculation result acquired by the calculation of similarity. For example, when the degree of similarity between the message 1500 and the template message of the entry 1400-1 is greater than or equal to a predetermined threshold value, the classifying unit 702 classifies the message ID of the message 1500 as the message ID “m0” of the entry 1400-1.

For example, the threshold value is set in advance and is stored in a storage device such as the ROM 302, the RAM 303, the magnetic disk 305, and the optical disk 307. Assuming that the threshold value is “0.8”, the degree of similarity “0.83” between the message 1500 and the template message of the entry 1400-1 is greater than or equal to the threshold value and therefore, the message ID of the message 1500 is “m0”.

If the degree of similarity between the message 1500 and the template message of the entry 1400-1 is less than the threshold value, the classifying unit 702 selects a new entry from the message dictionary DB 1400 and repeats the above series of process steps.

Detailed contents of the processing executed by the identifying unit 705 to identify the occurrence time point of the fault of the fault type T of the message pattern MPi will be described. The description will be made with reference to FIG. 16 taking an example of a case where the occurrence time of the fault of the fault type T1 of the message pattern MP1 is identified.

FIG. 16 is an explanatory diagram of an example of identification of the occurrence time of the fault. In FIG. 16, a time td is the time at which the sign of the fault of the fault type T1 of the message pattern MP1 is detected; a time tₛ1 is an occurrence time of a case example 1 of the fault D1 of the fault type T1; a time tₛ2 is an occurrence time of a case example 2 of the fault D1 of the fault type T1; and a time tₛ3 is an occurrence time of a case example 3 of the fault D1 of the fault type T1.

A valid time period VT is a time period that represents how long a sign is valid from the occurrence of the sign of a fault. For example, the valid time period (for example, 60 or 120 minutes) is set in advance and is stored in a storage device such as the ROM 302, the RAM 303, the magnetic disk 305, and the optical disk 307.

The identifying unit 705 first identifies the case examples 1 and 2 whose occurrence times are within the valid time period VT from the time td at which the sign of the fault of the fault type T1 is detected, from among the case examples 1 to 3 of the fault D1 of the fault type T1. Thereby, the occurrence time of the case example 3 occurring after the valid time period VT from the occurrence of the sign of the fault can be ruled out as the occurrence time of the fault of the fault type T1.

The identifying unit 705 identifies the case example 1 whose occurrence time is the earliest among the case examples 1 and 2, and identifies the occurrence time tₛ1 of the case example 1 as the occurrence time of the fault of the fault type T1. Thereby, the identifying unit 705 can identify the occurrence time tₛ1 of the fault D1 of the fault type T1 that occurs at the earliest time from the detection of the sign of the fault of the fault type T1, as the occurrence time of the fault of the fault type T1.

The identifying unit 705 may identify the occurrence time tₛ2 of the case example 2 whose occurrence time is the latest among the case examples 1 and 2 in the valid time period VT, as the occurrence time of the fault of the fault type T1. Thereby, the identifying unit 705 can identify the occurrence time tₛ2 of the fault D1 of the fault type T1, as the occurrence time of the fault of the fault type T1 (the occurrence time tₛ2 occurring within the valid time period VT and at the latest time from the detection of the sign of the fault of the fault type T1).

Procedures for various countermeasure support processes of the countermeasure support apparatus 100 according to the second embodiment will be described. A procedure for a lead time calculation process to calculate the lead time LTi of the message pattern MPi will be described.

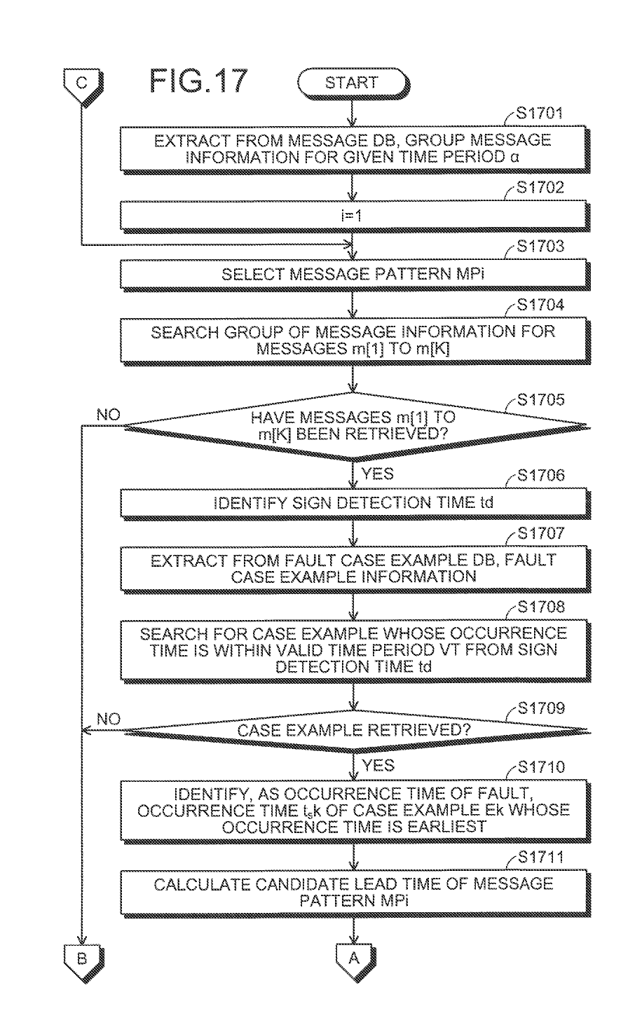

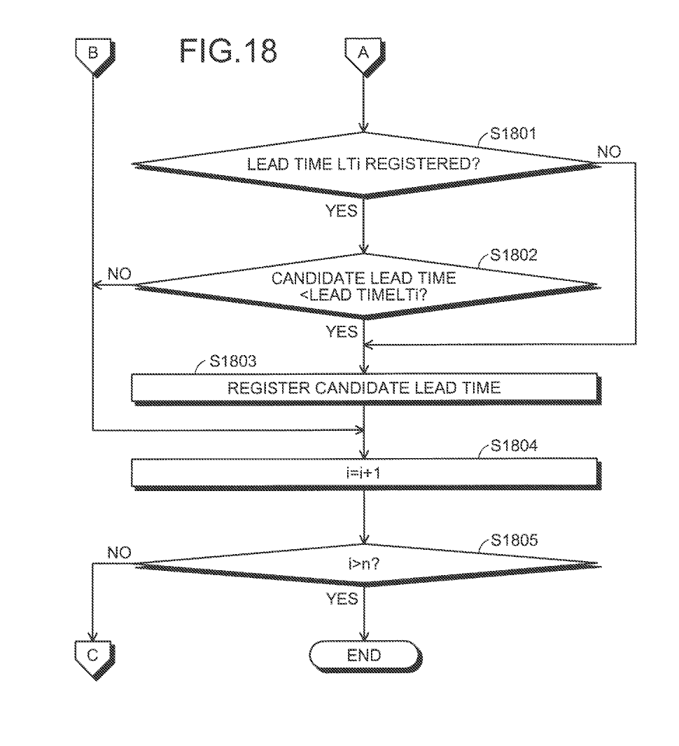

FIGS. 17 and 18 are flowcharts of an example of the lead time calculation process of the countermeasure support apparatus according the second embodiment.

In the flowchart of FIG. 17, the searching unit 704 extracts from the message DB 800, a group message information for the given time period a (step S1701).

The first selecting unit 703 sets “i” of the message pattern MPi to be “i=1” (step S1702). The first selecting unit 703 selects the message pattern MPi, from the message pattern DB 220 (step S1703).

The detecting unit 704 searches the extracted group of message information for the messages m[1] to m[K] of the message IDs included in the selected message pattern MPi (step S1704). The identifying unit 705 determines whether all of the messages m[1] to m[K] are retrieved (step S1705).

If the identifying unit 705 determines that at least any one message of the messages m[1] to m[K] is not retrieved (step S1705: NO), the procedure progresses to step S1804 depicted in FIG. 18.

On the other hand, if the identifying unit 705 determines that all of the messages m[1] to m[K] are retrieved (step S1705: YES), the identifying unit 705 identifies the latest occurrence time (hereinafter, referred to as “sign detection time td”) among the occurrence times of the messages m[1] to m[K] (step S1706).

The identifying unit 705 extracts from the fault case example DB 110, the fault case example information 400-j that corresponds to the fault type T of the message pattern MPi (step S1707). The identifying unit 705 searches among the case example data Ij of the fault case example information 400-j, for a case example whose occurrence time is within the valid time period VT from the sign detection time td (step S1708).

If the identifying unit 705 retrieves no case example (step S1709: NO), the procedure progresses to step S1804 depicted in FIG. 18.

On the other hand, if the identifying unit 705 retrieves a case example (step S1709: YES), the identifying unit 705 identifies the occurrence time tₛk of the case example Ek whose occurrence time is the earliest among the retrieved case examples, as the occurrence time of the fault of the fault type T of the message pattern MPi (step S1710).

The calculating unit 706 calculates the time interval from the sign detection time td until the occurrence time of the fault of the fault type T and thereby, calculates a candidate lead time of the message pattern MPi (step S1711) and the procedure progresses to step S1801 depicted in FIG. 18.

In the flowchart of FIG. 18, the calculating unit 706 determines whether the lead time LTi of the message pattern MPi is registered in the message pattern DB 220 (step S1801). If the calculating unit 706 determines that the lead time LTi is not registered (step S1801: NO), the procedure progresses to step S1803.

On the other hand, if the calculating unit 706 determines that the lead time LTi is registered (step S1801: YES), the calculating unit 706 determines whether the candidate lead time calculated at step S1711 depicted in FIG. 17 is shorter than the registered lead time LTi (step S1802). If the calculating unit 706 determines that the candidate lead time is longer than or equal to the registered lead time LTi (step S1802: NO), the procedure progresses to step S1804.

On the other hand, if the calculating unit 706 determines that the candidate lead time is shorter than the registered lead time LTi (step S1802: YES), the calculating unit 706 registers the candidate lead time into the message pattern DB 220 as the lead time LTi of the message pattern MPi (step S1803).

The first selecting unit 703 increments “i” of the message pattern MPi (step S1804) and determines whether “i” is greater than “n” (step S1805).

If the first selecting unit 703 determines that “i” is less than or equal to “n” (step S1805: NO), the procedure returns to step S1703 depicted in FIG. 17. On the other hand, if the first selecting unit 703 determines that the “i” is greater than “n” (step S1805: YES), the series of process steps according to the flowchart comes to an end.

Thus, the lead time LTi from the occurrence of the sign of the fault to the occurrence of the fault can be calculated for each message pattern MPi that indicates the sign of the fault. At step S1703, the message pattern MPi with which the occurrence probability of the fault is equal to or higher than the threshold value (for example, 0.5) may be selected. Thereby, the message pattern MPi with which the occurrence probability of the fault is lower than the threshold value can be ruled out from the message patterns for which the lead times LTi are to be calculated.

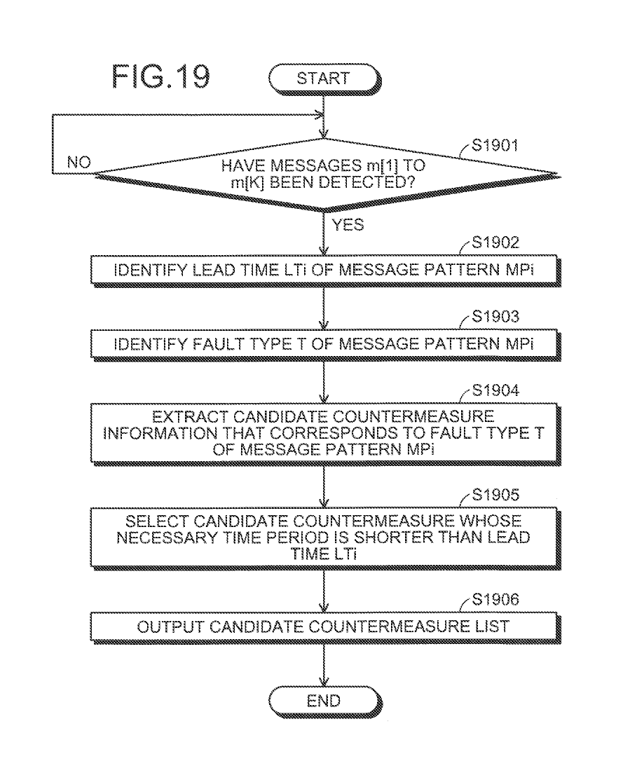

A procedure for a candidate countermeasure selection process of selecting a candidate countermeasure of the fault for which the sign is detected will be described. FIG. 19 is a flowchart of an example of a procedure for the candidate countermeasure selection process of the countermeasure support apparatus according to the second embodiment.

In the flowchart of FIG. 19, the detecting unit 708 determines whether the messages m[1] to m[K] included in the message pattern MPi have been detected (step S1901). The detecting unit 708 waits for the detection of the messages m[1] to m[K] included in the message pattern MPi (step S1901: NO).

When the detecting unit 708 detects the message pattern MPi (step S1901: YES), the second selecting unit 709 refers to the message pattern DB 220 and identifies the lead time LTi of the message pattern MPi (step S1902). The second selecting unit 709 refers to the message pattern DB 220 and identifies the fault type T of the message pattern MPi (step S1903).

The second selecting unit 709 extracts the candidate countermeasure information 600-j that corresponds to the fault type T of the message pattern MPi from the candidate countermeasure DB 230 (step S1904). The second selecting unit 709 refers to the extracted candidate countermeasure information 600-j and selects the candidate countermeasure whose time period necessary for execution is shorter than the lead time LTi (step S1905).

The output unit 707 outputs a candidate countermeasure list (for example, the candidate countermeasure list 1300 depicted in FIG. 13) that indicates the candidate countermeasures against the fault of the fault type T of the selected message pattern MPi (step S1906) and the series of process steps according to the flowchart comes to an end.

Thus, a proper candidate countermeasure can be selected and output that is suitable for the lead time LTi of the fault for which the sign is detected.

As described, the countermeasure support apparatus 100 according to the second embodiment enables the lead time LTi that is from the sign of the fault until the occurrence of the fault to be calculated, for each message pattern MPi representing the sign of the fault. Thus, the time period that is from the detection of the sign of the fault until the actualization of the fault can be estimated.

When the sign of a fault is detected in the countermeasure support system 200, the countermeasure support apparatus 100 according to the second embodiment enables a candidate countermeasure whose time period necessary for execution is shorter than the lead time LTi of the fault to be selected and output. Thus, when a sign of a fault is detected, the manager of the countermeasure support system 200 can cope with the sign by selecting a proper candidate countermeasure suitable for the fault for which the sign is detected.

The countermeasure support apparatus 100 according to the second embodiment enables the lead time LTi to be calculated using the occurrence time of the message m[k] whose occurrence time is the latest among the messages m[1] to m[K], which respectively represent the sign of the fault. Thus, the occurrence time of the message m[k] that occurs at the latest time among the messages m[1] to m[K], which respectively represent a sign of the fault is the detection time of the sign, and the lead time LTi can be calculated such that the time interval from the occurrence of the sign of the fault until the occurrence of the fault is short.

The countermeasure support apparatus 100 according the second embodiment enables the lead time LTi to be calculated using the occurrence time of the case example of the fault occurring within the valid time period VT from the occurrence of the sign of the fault. Thus, the occurrence time of the case example of the fault occurring after the valid time period from the occurrence of the sign of the fault can be excluded from the fault occurrence times to be identified.

The countermeasure support apparatus 100 according to the second embodiment enables the lead time LTi to be calculated using the occurrence time of the case example of the fault that occurs at the earliest time from the detection of the sign of the fault. Thus, the lead time LTi can be calculated such that the time interval from the occurrence of the sign of the fault until the occurrence of the fault is short.

The countermeasure support apparatus 100 according to the second embodiment enables the lead time LTi of the message pattern MPi to be statistically acquired from the plural calculation results (for example, the first and the second lead times), whereby deviation of the lead time LTi can be reduced.

Thus, according to the countermeasure support program, the countermeasure support apparatus, and the countermeasure support method, when a sign of a fault is detected, a proper candidate countermeasure that is suitable for the lead time of the fault can be selected; and the fault can be avoided in advance or the damage caused when the fault occurs can be minimized. Consequently, the down-time caused by the occurrence of the fault can be reduced and lost opportunities for providing services can be reduced.

The countermeasure support method described in the present embodiment may be implemented by executing a prepared program on a computer such as a personal computer and a workstation. The program is stored on a computer-readable recording medium such as a hard disk, a flexible disk, a CD-ROM, an MO, and a DVD, read out from the computer-readable medium, and executed by the computer. The program may be distributed through a network such as the Internet.

According to an aspect of the present invention, an effect is achieved that a time period from the occurrence of a sign of a fault until the occurrence of the fault can be calculated.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium stores a countermeasure support program that causes a computer to execute a process comprising:
calculating a time period elapsing from an occurrence timing of a message that is of a predetermined type and related to an operation of an apparatus in a monitored system, until an occurrence timing of a fault; and
outputting the calculated elapsed time period.

2. The non-transitory computer-readable recording medium according to claim 1, the process further comprising:
searching among messages occurring in the system, for a message that is of a predetermined type, is a sign of a specific fault, and occurs before occurrence of the specific fault;
identifying an occurrence time point of the specific fault by referring to a database that stores occurrence time points of faults occurring in the system;
calculating a time period from a time when a sign of the specific fault occurs until a time when the specific fault occurs, based on an occurrence time point of the retrieved message of the predetermined type and the identified occurrence time point of the specific fault; and
outputting a calculation result acquired at the calculating.

3. The non-transitory computer-readable recording medium according to claim 2, of the process further comprising
detecting the message of the predetermined type occurring in the system, wherein
the outputting includes outputting when the message of the predetermined type is detected, the calculated time period that is from occurrence of the sign of the specific fault until occurrence of the specific fault.

4. The non-transitory computer-readable recording medium according to claim 3, the process further comprising
selecting based on the time period that is from the occurrence of the sign of the specific fault until the occurrence of the specific fault and when the message of the predetermined type is detected, a candidate countermeasure against the specific fault, the candidate countermeasure being selected from a candidate countermeasure database that correlates and stores candidate countermeasures against the specific fault and a time period necessary for execution of the candidate countermeasure, wherein
the outputting includes outputting the selected candidate countermeasure against the specific fault.

5. The non-transitory computer-readable recording medium according to claim 4, wherein
the selecting the candidate countermeasure against the specific fault includes selecting from the candidate countermeasure database, a candidate countermeasure whose time period necessary for execution is shorter than the time period that is from the occurrence of the sign of the specific fault until the occurrence of the specific fault.

6. The non-transitory computer-readable recording medium according to claim 2, wherein
the specific type is a combination at least one type,
the searching for a message that is of a predetermined type includes searching among the messages occurring in the system, for a message of each type included in the combination, and
the calculating the time period until the time when the specific fault occurs, includes calculating a time interval that is from an occurrence time point that is latest among occurrence time points of messages retrieved at the searching, until the identified occurrence time point of the specific fault.

7. The non-transitory computer-readable recording medium according to claim 6, wherein
the identifying the occurrence time point of the specific fault includes identifying, by referring to the database, the occurrence time point of the specific fault occurring within a predetermined time period from the occurrence time point that is latest among the occurrence time points of the messages retrieved at the searching.

8. The non-transitory computer-readable recording medium according to claim 7, wherein
when a second time period from the occurrence of the sign of the specific fault until the occurrence of the specific fault is calculated after a first time period from the occurrence of the sign of the specific fault until the occurrence of the specific fault is calculated, the calculating includes calculating the time period from the occurrence of the sign of the specific fault until the occurrence of the specific fault based on the first and the second time periods.

9. A countermeasure support apparatus comprising
a processor configured to:
calculate a time period elapsing from an occurrence timing of a message that is of a predetermined type and related to an operation of an apparatus in a monitored system, until an occurrence timing of a fault; and
output the calculated elapsed time period.

10. A countermeasure support method executed by a computer, the countermeasure support method comprising:
calculating a time period elapsing from an occurrence timing of a message that is of a predetermined type and related to an operation of an apparatus in a monitored system, until an occurrence timing of a fault; and
outputting the calculated elapsed time period.
